(19) United States
(12) Patent Application Publication
(10) Pub. No.: US 2005/0144122 A1
(43) Pub. Date: Jun. 30, 2005

(54) System for reducing disputes of credit transactions

(76) Inventors: Lorrie A. Creveling, Jersey Shore, PA (US); Lisa Michele Hoggard, Marietta, GA (US); Sharon E. Aukema, Scottsdale, AZ (US); Julia A. Hugh, Phoenix, AZ (US)

Correspondence Address: Charles Rattner, Apt 7, 240 Wardwell St, Stamford, CT, 06902-5254, US

(21) Appl. No.: 10/749,696

(22) Filed: Dec. 31, 2003

(51) Int. Cl. G06F 17/60

(52) U.S. Cl. 705/39

(57) ABSTRACT

A financial institution calculates a merchant's dispute-to-record-of-charge (ROC) ratio for each merchant involved in a credit transaction processed by the financial institution. Any merchants that have a dispute-to-ROC ratio over an established threshold percentage will be selected for a process to reduce disputed charges. After selection, the financial institution sends the merchant a notification including a predetermined period of time in which the merchant must lower their dispute-to-ROC ratio to avoid chargeback fees. If the merchant does not lower their dispute-to-ROC ratio below the threshold percentage within the predetermined period of time, then the merchant will be billed the chargeback fee for every future dispute over the threshold percentage.

### FIELD OF THE INVENTION

This invention generally relates to automated electrical financial systems, and in particular it relates to credit transactions.

### BACKGROUND OF THE INVENTION

In current credit processing systems, a merchant submits an authorization to charge a purchase amount against an account holder's credit account after the account holder initiates a purchase. The authorization may be in the form of a record of charge (ROC) signed by the account holder, or it may be an electronic authorization in the case of credit transactions initiated, for example, over the Internet or via a telephone call by the account holder. The purchase amount (less traditional discount rates and the like) is then deposited into the merchant's financial account by a financial institution that maintains the credit account. The credit account is then debited for the full purchase amount by the financial institution. The financial institution will then report the transaction to the account holder in the form of a periodic (i.e. monthly) summary of transactions involving the credit account.

On occasion, an account holder may dispute a credit transaction, for example, due to non-fulfillment of a purchase of a product or service, an assertion that the transaction was not authorized, or that product/service expectations have not been met. A payment dispute with a merchant may be initiated by an account holder through the financial institution that maintains the credit account. Upon notification of a disputed charge, the amount paid in the disputed transaction is immediately withdrawn from the merchant's financial account, and a chargeback fee is usually assessed to the merchant for each disputed transaction, in addition to the transaction amounts previously paid.

A chargeback fee of between $10.00 and $20.00 is commonplace. It is also common for certain financial institutions to charge a higher chargeback fee on all transactions to riskier merchants with excessive chargebacks. This fee can range from $25-$100 per disputed transaction.

When a chargeback is generated, the financial institution must research the facts to determine which party is indeed responsible for the credit transaction. National and global financial institutions process tens of millions of credit transactions annually, typically resulting in hundreds of thousands of such disputed transactions, which equates to a dispute-to-ROC ratio of between one and two percent for the marketplace. Due to the sheer number of disputes, financial institutions can spend millions of dollars resolving them all. In addition, the merchant may refute a chargeback by presenting a proof of purchase, an account holder's signature, a proof of delivery of the purchased product or services, or the like. Such merchant disputes further add to the administrative costs associated with dispute resolution.

In order to alleviate their burden of investigation, a financial institution may choose to write off certain segments of disputed transactions, such as those under a particular dollar amount (e.g. transaction amounts of $25.00 or less) after a dispute by a merchant or an account holder. The write-off segment can total in the hundreds of thousands of dollars for a national or global financial institution. Reducing the need for write-offs would therefore present an additional significant opportunity to reduce administrative expenses in resolving disputed transactions.

Oftentimes though, it is the inadequate accounting or procurement practices of a merchant that are responsible for many disputed transactions. If such merchant processes could be proactively addressed and remedied, a financial institution could realize a substantial cost avoidance in resolving disputed transactions. The present system of assessing chargebacks does not proactively address the correction of merchant behavior that leads to disputed transactions.

Accordingly, there is a need for a system for reducing disputes of credit transactions that addresses certain problems in existing technologies.

### SUMMARY OF THE INVENTION

It is an object of the present disclosure, therefore, to introduce a system for processing credit transactions, in which a ratio of disputed credit transactions to total credit transactions is monitored for one or more categories of merchants over a period of time. This ratio may then be used to determine an allowable threshold of dispute-to-ROC ratio for a group of merchants that undertake credit transactions with account holders of a financial institution. The threshold ratio may be the same for all merchants or may be specific to a particular category of merchants, such as those in a particular industry classification code or category, or by a volume of annual merchant transactions. The threshold value may be based on the average ratio of disputes for a category and may be lower for those categories that have historically fewer disputes.

Continuing with the process, a dispute-to-ROC ratio for a first merchant is determined, and if its dispute-to-ROC ratio exceeds the established threshold ratio, the merchant is assessed a chargeback fee for each transaction that causes it to exceed the threshold ratio. The dispute-ROC ratio may be calculated from all credit transactions (including purely electronic or telephonic transactions) involving a merchant and not merely the transactions in which a paper ROC is actually generated.

Additionally, a financial institution may establish a threshold number of time periods (such as a number of months or a number of successive months) in which the merchant's dispute-to-ROC may exceed the threshold ratio before any chargeback fees are assessed. This threshold number of time periods may also vary for different categories of merchants based on historical data.

If a merchant has exceeded the threshold number of time periods, the chargeback fee may be assessed. If however, the merchant has not exceeded the threshold number of time periods, the financial institution may instead generate and transmit one or more notifications to the merchant in which the merchant is apprised of the possibility of future chargeback fees, educated about ways to reduce disputes with account holders, and/or given a period of time to remediate their credit transaction processes before chargeback fees are assessed.

### BRIEF DESCRIPTION OF THE DRAWINGS

Further aspects of the present disclosure wilt be more readily appreciated upon review of the detailed description of its various embodiments, described below, when taken in conjunction with the accompanying drawings, of which:

FIG. 1 is a flowchart depicting an exemplary process for monitoring and reducing disputes involving credit transactions with a merchant.

### DETAILED DESCRIPTION OF THE SPECIFIC EMBODIMENTS

The present disclosure introduces a credit processing system that promotes cost avoidance in resolving disputed credit transactions by educating merchant on ways to reduce their dispute ratio and by passing a portion of associated costs to the merchants having excessive dispute-to-ROC ratios. The system motivates merchants to change their operating policies and procedures with respect to credit transactions in order to reduce processing errors that can lead to disputes. A financial institution implementing this credit processing system can realize substantial cost savings, and in addition, can attract new merchants into accepting payments from the financial institution's account holders due to the various benefits the present system provides in comparison to existing credit processing systems.

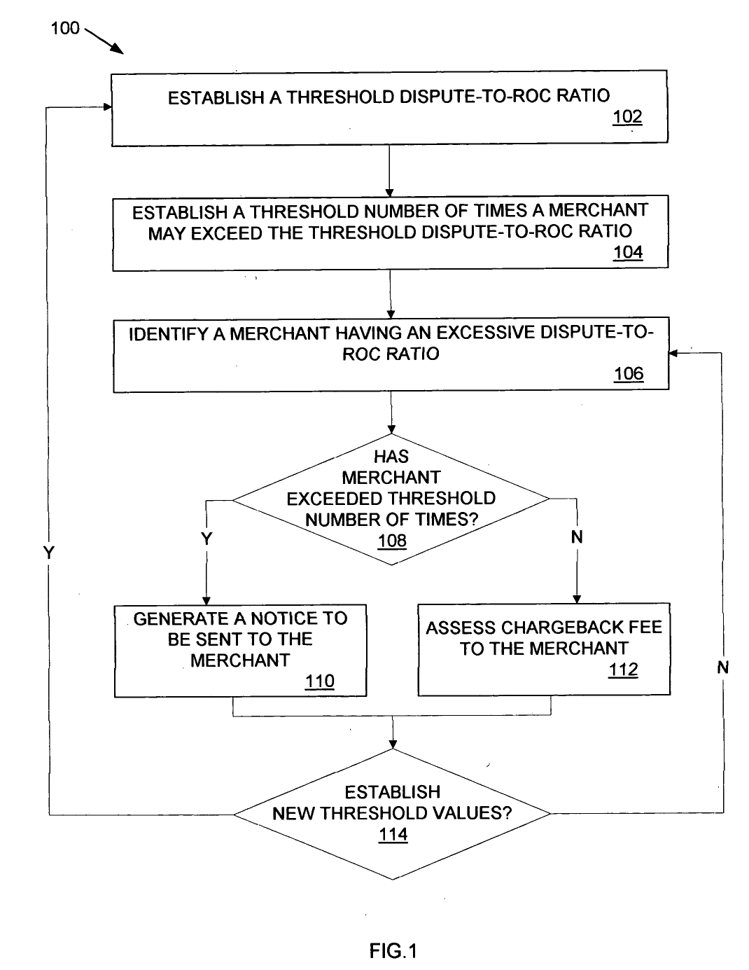

With reference now to FIG. 1, various embodiments of a system for reducing credit transaction disputes will now be described in detail. FIG. 1 depicts a process 100 for monitoring and reducing disputes involving credit transactions. The process 100 may be performed, in whole or in part, by an automated system of one or more computers belonging to a financial institution, which include processors and associated memories for storing and retrieving programmed processing instructions that implement its various steps. The financial institution's computers are operative to store and retrieve transaction information, credit account details, merchant information and other financial information using one or more enterprise databases. The financial institution computers further transmit appropriate credit transaction information to, and receives credit transaction information from, one or more computers operated by a merchant over a network. It is readily contemplated that the network may be any type of computer or telecommunications network over which financial transaction data and other electronic information may be communicated, including but not limited to a local area network (LAN), a wide area network, a corporate intranet, a fiber optic network, a wireless network, the Internet, or any combination or interconnection of the same. The network may include known encryption techniques and security protocols for securing transmitted financial information. Such financial information may be communicated either directly between a merchant and the financial institution or through a third party payment processing system, as is common in current credit transaction processing systems.

The process 100 commences when a financial institution establishes a threshold dispute-to-ROC ratio for merchants involved in credit transactions with the financial institution's account holders (step 102). For example, the threshold dispute-to-ROC ratio may be set as 3% of transactions within a given period of time (such as thirty days, one month or one quarter-year). The threshold ratio may, in various embodiments, be the same for all merchants. In further embodiments, separate threshold ratios may be established for one or more groups or categories of merchants. The categories can be based, for example, on an industry code for merchants, such as their standard industrial classification (SIC) code, or may likewise be based on financial risk factors associated with each industry category, an annual volume of transactions undertaken by the merchant or the payment channel that is employed by the merchant in executing credit transactions. Other categories of merchants may be readily used.

The threshold ratio may be determined from historical credit transaction data stored by the financial institution, in which an average or median historical dispute-to-ROC ratio is calculated for a designated group of merchants. The established threshold ratio may then be based on this average or median value. The threshold ratio may be based on additional factors such as the dollar amount of a transaction, wherein a lower threshold ratio may be applied to higher value transactions. Other manners of determining the threshold value may likewise be used.

Returning to the process 100, the financial institution may also establish a threshold number of time periods in which a merchant may exceed the threshold dispute-to-ROC ratio before chargeback fees are assessed (step 104). The threshold number of time periods may, in some embodiments, be greater than one. For example, the established threshold number of time periods may be established two one-month periods, or as three consecutive 30-day periods. The threshold number of periods allowed may be applied to all merchants or may be different for different categories of merchants. For example, merchants in higher-risk categories may have a lower threshold value established than merchants in less risky categories. The financial institution may also choose not to allow more than one period of excessive disputes, in which case this threshold value may be established as zero time periods. Other manners for establishing this threshold value may likewise be used.

Continuing with the process 100, the financial institution next identifies those merchants having an excessive dispute-to-ROC ratio (step 106). This may be done by identifying, for each merchant, a total number of credit transactions involving that merchant and any account holder within a recent period of time, and the number of such credit transactions that have been disputed by various account holders. The merchant's dispute-to-ROC ratio is then calculated by dividing the latter by the former, and then comparing that value to the threshold ratio established in step 102 above.

When a merchant has exceeded the threshold dispute ratio, the financial institution next determines whether that merchant has exceeded the established threshold number of time periods in which the threshold dispute ratio may be exceeded without chargeback fees (step 108). If the threshold number of time periods has not been met, the process 100 continues to step 110 below. Otherwise the process 100 continues to step 1 2 described further below.

At step 110, if a merchant has exceeded the threshold dispute ratio, but has not exceeded the threshold number of time periods, the financial institution may generate and transmit one or more notices addressed to the merchant. The notice may apprise the merchant of the possibility of future chargeback fees due to their current dispute ratio and the allowed threshold ratio, may educate the merchant about ways to reduce disputes with account holders by implementing or improving transaction processing systems and procedures, and/or may announce a period of time in which the merchant must remediate their credit transaction processes before chargeback fees are assessed. The notifications may be tailored based on the type of credit processing systems that are actually employed by a merchant. Other similar types of notices may likewise be provided. The financial institution may also establish a hierarchy of notices to be sent to a merchant, such as generating a simple notification upon a first time period of excessive disputes, generating warning notifications and remedial suggestions after a second time period of excessive disputes, or the like.

When a merchant has exceeded both the threshold dispute ratio and the threshold number of time periods, the financial institution may instead assess chargeback fees to the merchant (step 112). The chargeback fee may be based on the number of disputes that cause the merchant to exceed the threshold dispute ratio. The chargeback fee in the present system is applied only for each such excessive disputed transaction and not to all disputed transactions.

The amount of the chargeback fee may be the same for all merchants. In various embodiments, though, the chargeback fee may vary based on the industry category of the merchant, associated risk factors associated with its category, the payment channel employed by the merchant, the amount of the disputed transaction, or the like. In one example, the chargeback fee may be between $5.00 and $15.00 per transaction, based on these various factors.

Finally, from step 110 or step 112 above, the process 100 continues with the financial institution periodically or otherwise establishing new threshold values (step 114). New threshold values may be established, for example, when trends in historical transaction dispute data changes significantly enough to require a change in the established threshold dispute ratios or the threshold number of time periods of excessive disputes allowed. If new threshold values are needed, the process 100 returns to step 102 above. Otherwise the process 100 returns to step 106 above where further merchants having excessive disputes are identified.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims.

1. A method for processing credit transactions, comprising:
establishing a threshold ratio of disputed credit transactions to total credit transactions for a period of time;
calculating a number of disputed credit transactions and a number of credit transactions involving a merchant in the period of time;
calculating a ratio of the number of disputed credit transactions to the number of credit transactions for the merchant; and
assessing a chargeback fee against the merchant only for each disputed transaction involving the merchant that exceeds the threshold ratio, when the merchant's ratio is at least equal to the threshold ratio.

2. The method of claim 1, the period of time comprising thirty days.

3. The method of claim 1, the threshold ratio comprising three percent.

4. The method of claim 1, further comprising:
establishing the threshold ratio based on an industry category including the merchant.

5. The method of claim 4, the industry category comprising a standard industrial classification code.

6. The method of claim 1, further comprising:
establishing the threshold ratio based on an average transaction volume of the merchant.

7. The method of claim 1, further comprising:
establishing a threshold number of time periods in which the ratio of disputed credit transactions to may exceed the threshold ratio;
calculating a number of time periods in which the ratio of the number of disputed credit transactions to the number of credit transactions for the merchant is at least equal to the threshold value; and said assessing further comprising:
assessing the chargeback fee against the merchant only for each disputed transaction that exceeds the threshold ratio, when the ratio is at least equal to the threshold ratio for the period of time and the number of time periods for the merchant is at least equal to the threshold number of time periods.

8. The method of claim 7, wherein the threshold number of time periods is greater than one.

9. The method of claim 8, further comprising:
generating a notice for transmission to the merchant when the number of time periods for the merchant is greater than zero and less than the threshold number of time periods, the notice including: the ratio of the number of disputed credit transactions to the number of credit transactions for the merchant, the threshold ratio, the number of time periods for the merchant and the threshold number of time periods.

10. The method of claim 9, further comprising:
transmitting the notice to the merchant.

11. The method of claim 8, further comprising:
generating a notice for transmission to the merchant when the number of time periods for the merchant is greater than zero and less than the threshold number of time periods, the notice including at least proposed business solution for reducing the number of disputed credit transactions involving the merchant.

12. The method of claim 7, wherein the threshold number of time periods is based on an industry category including the merchant.

13. The method of claim 7, the threshold number of time periods comprising a threshold number of consecutive time periods.

14. A method for processing credit transactions, comprising:
calculating a ratio of disputed credit transactions to total credit transactions for each of a plurality of industry categories for a previous period of time;
determining a first threshold ratio for a first of the industry categories based on said calculating;
determining a second threshold ratio, lower than the first threshold ratio, for a second of the industry categories based on said calculating, the second of the industry categories having a lower ratio of disputed credit transaction to total credit transactions in the previous period of time than the first of the industry categories.

15. The method of claim 14, further comprising:
calculating a dispute-to-record of charge (ROC) ratio for a merchant in the first of the industry categories; and
assessing a chargeback fee when the dispute-to-ROC ratio is at least equal to the first threshold ratio.

16. The method of claim 15, wherein the chargeback fee is assessed for each disputed credit transaction that exceeds the first threshold ratio.

17. The method of claim 14, further comprising:
determining a first threshold number of time periods in which the ratio of disputed credit transactions for a merchant in the first of the industry categories exceeds the first threshold ratio, based on said calculating; and
determining a second threshold number of time periods, lower than the first threshold number of time periods, in which the ratio of disputed credit transactions for a merchant in the second of the industry categories may exceed the second threshold ratio, based on said calculating.

18. The method of claim 17, further comprising:
calculating a dispute-to-record of charge (ROC) ratio for the merchant for a plurality of previous time periods;
calculating a number of time periods in which the dispute-to-ROC ratio of the merchant is greater than the first threshold ratio; and
assessing a chargeback fee if the merchant's current dispute-to-ROC ratio is at least equal to the first threshold ratio and the number of time periods for the merchant is at least equal to the first threshold number of time periods.

19. The method of claim 18, further comprising:
generating a notice for transmission to the merchant when the merchant's current dispute-to-ROC ratio is at least equal to the first threshold ratio and the number of time periods for the merchant is less than the first threshold number of time periods, including a predetermined period of time in which the merchant must lower their dispute-to-ROC ratio to avoid chargeback fees.

20. An apparatus for processing credit transactions, comprising:
a processor; and
a memory operative with the processor to store and retrieve a sequence of processing instructions that enable the processor to:
calculate an average dispute-to-record of charge (ROC) ratio for each of a plurality of industry categories;
establish a threshold dispute-to-ROC ratio for a first of the industry categories based on its average dispute-to-ROC ratio,
calculate a dispute-to-ROC ratio for a merchant in the first of the industry categories; and
assess a chargeback fee to the merchant when the merchant's dispute-to-ROC ratio is greater than the threshold dispute-to-ROC ratio, the chargeback fee applied to each disputed transaction involving the merchant that causes the merchant to exceed the threshold dispute-to-ROC ratio.
